(19) United States
(12) Patent Application Publication
(10) Pub. No.: US 2009/0110421 A1
(43) Pub. Date: Apr. 30, 2009

(54) Photographic Plotting Process and Arrangement for Tracing a Computer-stored Grid Image on a Flat Photosensitive Carrier

(75) Inventor: ROBIN PAGAN, Stuttgart (DE)

Correspondence Address: WOODLING, KROST AND RUST, 9213 CHILLICOTHE ROAD, KIRTLAND, OH, 44094, US

(73) Assignee: MIVA Technologies Gmbh

(21) Appl. No.: 12/252,551

(22) Filed: Oct. 16, 2008

(30) Foreign Application Priority Data
Oct. 31, 2007 (DE) 10 2007 051 990.9

(51) Int. Cl. G03G 15/043

(52) U.S. Cl. 399/51

(57) ABSTRACT

The grid image T (overall image) is traced in dots by a computer program as a sequence of image sections (R1, R2, R3, R4, . . . ) on a tracing carrier (1) moving through an exposure station in direction v. All the dots in an image section are traced simultaneously. The image sections are traced at moments (t1, t2, t3, t4) of exposure to a flash light each of which takes place when the tracing carrier (1) has moved a distance (d) which is always equal. Successive images always partially overlap one another in such a way that the overlapping parts coincide with a section of the overall image being traced. The tracing is carried out by means of a light-controlling unit, preferably a semiconductor chip with tilting-mirror elements with light-controlling elements arranged similarly to a matrix. In order to trace each image section the light-controlling unit is loaded with the corresponding control pattern by a computer.

The invention concerns a photographic plotting process and an arrangement for tracing a computer-stored grid image on a flat photosensitive carrier.

Photographic plotting processes and arrangements are used, among other things, for manufacturing photographic patterns for printed circuit boards.

According to the current state of the art, a number of different processes and arrangements are already known.

The U.S. Pat. No. 5,434,600 describes a tracing system where a tracing carrier is arranged on a rotating drum on which line sections with image elements can be traced in succession.

The U.S. Pat. Nos. 4,739,416 and 4,357,619 describe tracing systems where the tracing carrier is also arranged on a rotating drum. The tracing process takes place line by line and requires a perforated template and a number of light sources.

DE 41 21 809 A1 describes an exposure and modulation system which has a two-dimensional light modulator with several rows of light-modulating cells and a device for depicting the light modulator on a photosensitive carrier. The light modulator and the tracing carrier are moved against one another according to the movement of information or intake of new information in the rows of the light modulator.

Patent no. DE 197 16 240 describes a process for tracing a computer-stored grid image on a photosensitive carrier. The grid image consisting of grid dots is traced by means of a perforated template with a number of holes. Each hole permits the passage of a controlled beam of light to trace an image element which corresponds to a grid dot on the tracing carrier.

The tracing carrier is divided into imaginary grid-image sub-areas arranged similarly to a matrix. Each sub-area has several image-element positions arranged similarly to a matrix. The perforated template and an arrangement of controllable light-beam elements are moved with reference to the tracing carrier in order to trace the image elements in the various image-element positions. At least one part of the image elements in the same image-element positions of the grid-image sub-areas of the tracing carrier is traced at the same time, whereas the image elements of one grid-image sub-area of the tracing carrier are traced one after the other. The arrangement of controllable light-beam elements can be depicted by an LCD matrix or a tilting-mirror semiconductor chip.

The LCD matrix can be exposed either to constant light or a xenon or laser flash. The tilting-mirror semiconductor chip is exposed to flash.

All the previous processes and arrangements operating with flash exposure (always with one source of light) have the drawback of not achieving homogeneity in the intensity of the image dots distributed over the tracing surface because the light energy acting on an image-grid dot position differs according to the position of this dot in the exposure area.

The purpose of the invention is therefore to provide a process or an arrangement for tracing which improves the homogeneity of the tracing while using a flash whose energy would not be sufficient to trace an image dot with only one exposure.

The purpose of the invention is fulfilled by the features given in the characterising section of claims 1 and 18.

Advantageous developments of the invention are identified in the sub-claims.

One example and illustrations of the way in which the invention works are shown in the drawings which are described in more detail below.

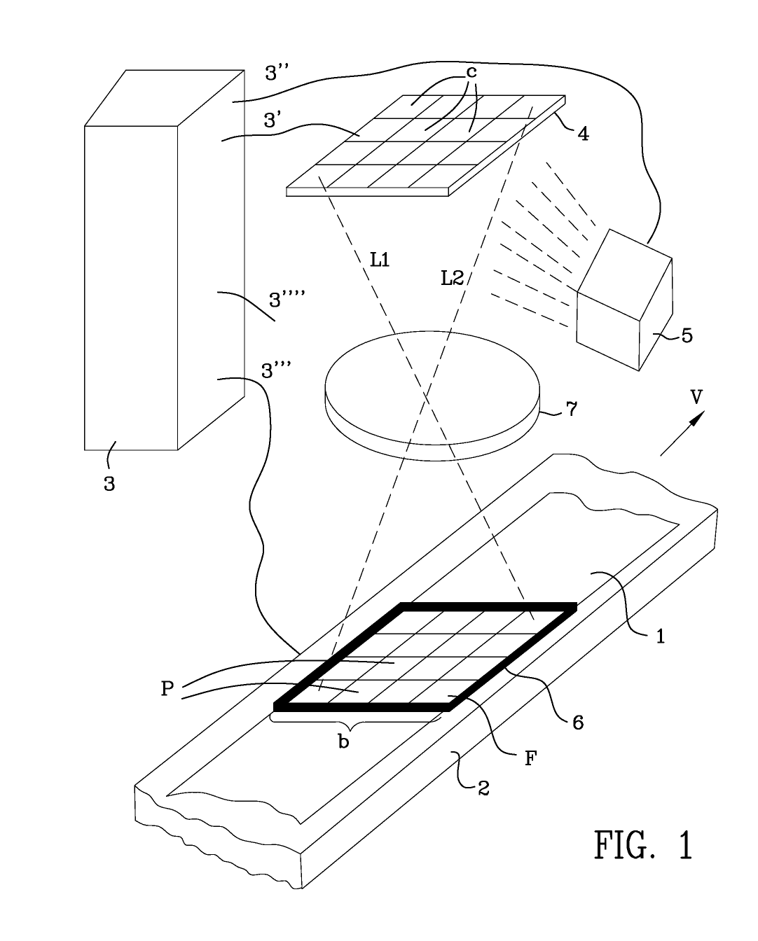

FIG. 1 shows a schematic diagram of an arrangement according to the invention for tracing a computer-stored grid image on a flat photosensitive carrier.

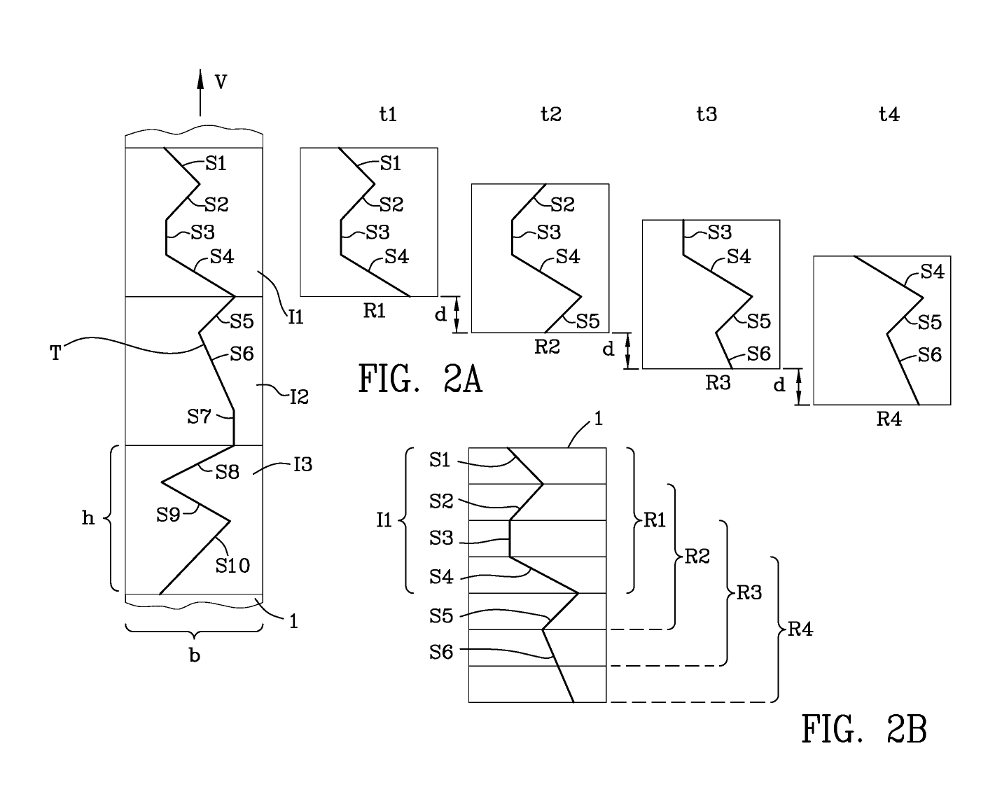

FIG. 2A shows a “step-by-step” diagram of the image-tracing process using an example of an overall image to be traced.

FIG. 2B shows a schematic diagram of four image sections R1, R2, R3 and R4 partially overlapping one another to form part of the overall image.

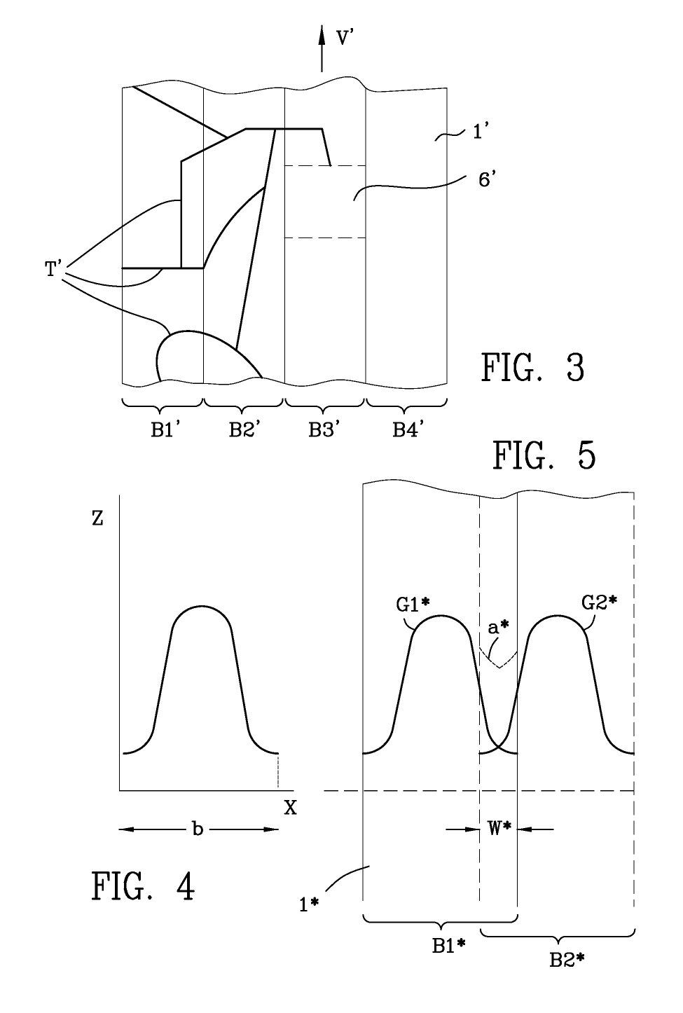

FIG. 3 shows a schematic diagram of a tracing carrier on which the image is traced in strips.

FIG. 4 shows the function of the tracing intensity z for image dots with reference to their position over the width of an image section.

FIG. 5 shows a schematic diagram of two strips of an image tracing partially overlapping one another, each of which shows a pattern of image-dot intensity similar to a Gaussian curve with reference to the position of the dots over the width of the strip.

FIG. 1 shows a schematic diagram of an arrangement according to the invention for tracing a computer-stored grid image on a flat photosensitive carrier 1. The grid image T (see FIG. 2) to be traced on the flat photosensitive tracing carrier 1 is stored in a computer 3. The grid-image tracing process is controlled by a computer program.

The computer 3 is connected with a light-controlling unit 4 by a control cable 3′.

The light-controlling unit 4 is exposed to a flashing light at certain intervals. The flash is generated in a flash unit 5.

The computer 3 is connected with the flash unit 5 by a control cable 3″.

The light-controlling unit 4 consists of a number of light-control elements c arranged similar to a matrix.

The image is traced in an exposure-area field F of an exposure station 6.

The exposure station 6 assumes the same position with reference to the light-controlling unit 4 at each moment of exposure. The exposure-area field F is divided into imaginary image-dot grid positions p arranged like a matrix.

The image-dot grid positions p of the exposure-area field F and the matrix-like light-control elements c of the light-controlling unit 4 correspond to one another.

Each light-control element is assigned to an image-dot grid position of the exposure-area field F.

The tracing carrier (1) is located on a moving device (e.g. a transport carriage) which is moved in a straight line v at a constant speed under the light-controlling unit 4.

The level at which the tracing carrier 1 is located and the level at which the light-controlling unit 4 is located are always at the same distance from one another.

For each flash, the light-controlling unit 4 receives a control pattern for tracing the image in the exposure-area field F of the exposure station 6 from the computer program. This control pattern controls the light-controlling elements in such a way that when they are exposed to the flash, each light-controlling element points (or does not point) a beam of light at the image-dot grid position of the exposure-area field F assigned to it. The beam of light striking an image-dot grid position causes this image dot to be traced. A non-striking beam of light causes no image dot to be traced.

The tracing of an image in the exposure-area field F takes place at the same time for all image-dot positions.

A lens 7 which controls the scale of the image is located between the tracing carrier 1 and the light-controlling unit 4. The image dots are traced with sides and heights reversed with reference to their corresponding light-controlling elements, as is indicated for example by light beams 11 and 12.

The computer 3 is connected to the moving device 2 by means of a control cable 3′″ to record the current position.

The data for the grid image to be traced are passed to the computer 3 via the cable 3″″.

FIG. 2A shows a “step-by-step” diagram of the image-tracing process according to the invention using an example of an overall image T to be traced.

FIG. 2B shows a schematic diagram of four image sections R1, R2, R3 and R4 partially overlapping one another to form part of the overall image in image field I1.

In order to better understand the tracing process, e.g. of the first image section R1 in the exposure station according to a corresponding control pattern in the light-controlling unit (4), the following should be noted:

The control pattern controls the tracing of the image elements in all the image-element positions of the exposure surface arranged similar to a matrix. These image elements correspond to the grid dots of the computer grid image for the image section R1. An image element is generated for a grid dot in the “on” state. No image element is generated for a grid dot in the “off” state, i.e. for a missing image element.

For a grid dot in the “on” state, a certain control command to the light-controlling element assigned to that grid dot causes it, when it is exposed to light, to direct a light beam at the tracing carrier to generate an image dot at a position assigned to that light-controlling element.

For a grid dot in the “off” state, a certain control command to the light-controlling element assigned to that grid dot causes it, when it is exposed to light, to direct no light beam at the tracing carrier to generate an image dot.

The control pattern for the light-controlling unit includes the control commands for all light-controlling elements by means of which the image section R1 is generated at the same time.

The overall image T to be traced extends over three imaginary image fields I1, I2, I3 arranged beneath one another on the tracing carrier 1.

The overall image T consists (for example) of the trace segments s1, s2, s3, s4, s5, s6, s7, s8, s9, s10. As already noted, the tracing carrier 1 located on the moving device 2 shown in FIG. 1, is moved continuously in direction v beneath and past the light-controlling unit 4.

At the moment t1 of the flash, the light-controlling unit 1 is loaded with the correct control pattern for tracing the first image section R1. During the brief exposure to the flash at moment t1, this image section R1 is traced on the tracing carrier in exposure station 6 (FIG. 1) in the area of exposure surface F. (Exposure surface F is the same size as the area of an image section or an image field).

The duration of the flash is so short that any blurring caused by motion during the tracing of the image is negligible.

The image section R1 traced at the moment t1 of the flash consists of the trace segments s1, s2, s3 and s4.

For reasons of simplicity, the first image section R1 is shown separately beside the tracing carrier 1 (with the imaginary overall image T to be traced). The corresponding trace segments s1, s2, s3 and s4 of the image section R1 are shown displaced only to the side with reference to the trace segments s1, s2, s3 and s4 of the imaginary overall image T, but not in height.

At succeeding flashes, further image sections are traced which overlap partially on the tracing carrier. A flash exposure is triggered when tracing carrier 1 has moved an equal distance d with reference to the light-controlling unit 4.

For flash moment t2 (the moving device with the tracing carrier has continued to move in direction v by distance d since moment t1) the light-controlling unit is loaded with a control pattern for tracing the second image section R2. This second image section R2 is traced on the tracing carrier in the same way as image section R1 at exposure station 6. The second image section consists of trace segments s2, s3, s4, and s5. For reasons of simplicity it is shown separately displaced to the side beside tracing carrier 1 with the imaginary overall image T and beside the first image section R1. The same trace segments e.g. s3 in overall image T and image sections R1 and R2 are at the same height.

The first image section R1 is traced at moment t1 and the second image section R2 at moment t2. Both image sections R1 and R2 appear on the tracing carrier 1 displaced by distance d. The image sections overlap to such an extent (FIG. 2B) that (for example) segment s3 of the first image section R1 coincides with segment s3 of the second image section R2 on the tracing carrier 1.

The distance of movement d is less than the edge length h of an image field (or of an image section). For reasons of simplicity, it is only one quarter of the length of edge h in this example.

In functioning devices, d may be (for example) 1 mm for an image-section edge length h of 10 mm. h does not have to be an exact multiple of d.

For flash moment t3 (at flash moment t3, the moving device with the tracing carrier has continued to move in direction v by an equal distance d since moment t2) the light-controlling unit 4 is loaded with a control pattern for tracing the third image section R3 at the exposure station. The third image section R3 consists of trace segments s3, s4, s5, and part of s6.

As described above, the third image section R3 and the fourth image section R4 in FIG. 2A are shown shifted to the side with reference to the imaginary overall image T and image sections R1 and R2.

As FIG. 2B shows, the image sections R1, R2 and R3 overlap on the tracing carrier 1 to such an extent that (for example) segment s3 of R1, R2 and R3 coincide at the same place on the tracing carrier 1.

For flash moment t4 (at flash moment t4, the moving device with the tracing carrier has continued to move in direction v by an equal distance d since moment t3) the light-controlling unit 4 is loaded with a control pattern for tracing a fourth image section R4 at the exposure station 6. The fourth image section R4 consists of trace segments s4, s5, and s6. The fourth image section R4 also appears displaced to the side in FIG. 2A.

Through the overlapping of the four image sections R1, R2, R3 and R4 (see FIG. 2B) segment s4 (for example) of the imaginary overall image T (FIG. 2A) has undergone four successive exposures (at flash moments t1, t2, t3 and t4). This makes it possible to trace an image with relatively low flash light energy.

The very high light energy of the flash required to trace an image with only one single exposure (no such flash unit is currently available) can therefore be replaced by multiple exposure according to the invention.

The image section to be traced for each flash moment is transmitted to the light-controlling unit by the computer program in the form of a control pattern which takes account of the movement of the tracing carrier in direction v between two successive flashes.

FIG. 3 shows a schematic diagram of a tracing carrier 1′ on which the image is traced in strips.

The image T′ to be traced extends over several image-area strips B1′, B2′, B3′ and B4′. The image is traced in strips. The exposure area in the exposure station has the width b of one strip. The tracing carrier is moved in direction v′ with reference to the light-controlling unit (not shown).

According to the invention, the image sections overlap partially during the tracing of the image. After the image is traced in one strip, the moving device on which the tracing carrier is located, is set back and shifted to the side by the width of one strip. The tracing of the image in the next strip then begins. FIG. 3 shows the current status of a tracing process T′ which has already taken place for strips B1′, B2′ and part of B3′.

The tracing of partially overlapping image sections results in improved homogeneity of image quality (tracing intensity) of the individual image dots at the image-dot grid positions in the direction of movement v or v′ of the tracing carrier.

However, differences in the homogeneity of tracing intensity may be produced vertically to this direction of movement v (v′).

FIG. 4 shows the function of the tracing intensity z for image dots with reference to their position across the direction of movement v or v′ of the tracing carrier, i.e. over the width b of an image section. This function may take the shape of a Gaussian curve, i.e. the intensity of the tracing is greater at the centre of an image section than at its lateral edges.

In order to reduce these differences (vertically to the direction of movement v or v′) they are measured first of all as a function of location.

Taking these differences into account (and in order to reduce them) the light-controlling elements in the light-controlling unit can be controlled by the computer program in such a way that in the image sections, light-controlling elements for image dots of originally excessive intensity are de-activated.

Alternatively, it is also possible to locate an optical filter (not shown) between the light-controlling unit (4) and the tracing carrier (1) in order to reduce these differences.

Another way of reducing these differences is to trace the image in strips where the strips overlap towards the edges.

FIG. 5 shows a schematic diagram of two strips B1* and B2* of an image tracing partially overlapping one another towards their edges, where each strip shows an image-dot intensity similar in shape G1*, G2* to a Gaussian curve in FIG. 4.

For the tracing of the image in the overlap area w*, the tracing in strip B1* overlaps with that in strip B2*.

Strip B1* is traced taking the curve G1* into account and strip B2* is traced taking the curve G2* into account. Thus, for the tracing of an image dot in the overlap area w*, this results in an intensity produced by adding the ordinate values of the curves G1* and G2* (dotted drawing a*).

The invention is not limited to the above-mentioned examples.

The shifting of the tracing carrier with reference to the light-controlling unit or of the light-controlling unit with reference to the tracing carrier can take place by stopping and starting. The conversion of the control pattern of the light-controlling unit into controllable beams of light for tracing the image can take place in different ways:

a) by means of a semiconductor chip with tilting-mirror elements which is exposed to a flash of light,

b) by means of a matrix of controllable light-valve elements which are exposed to a flash of light,

c) by means of a matrix of flash-emitting elements.

The size of the exposure field in the exposure station (6) area field can be determined by a lens (7) of the correct scale arranged between the light-controlling unit (4) and the tracing carrier (1).

According to the invention, the exposure of the tracing carrier with flashes of equal or virtually equal energy produces tracings of constant depth, i.e. the exposed areas penetrate the entire thickness of the photosensitive layer and are removed during the caustic process following exposure.

However, the invention also makes it possible to produce tracings of varying depth.

To do this, the image is traced during several passes of the tracing carrier through the exposure station. At each pass, the tracing carrier is exposed to flashes of equal or virtually equal energy. However, the energy of the flash varies from one pass to another. At each pass, the moving device has to be started from the same position in direction v.

In this way, the invention makes it possible to generate three-dimensional structures in the photosensitive layer. Such structures can be used as optical elements for optical or phase focusing, e.g. as a lens or lens field for the optical focusing of light or phase-focusing of light, e.g. in so-called Fresnel diffraction grids.

The process of focusing light by using a Fresnel diffraction grid based on the Huygens principle is well known. Such diffraction grids are described as so-called Fresnel zone plates in the publication “OPTICS”, Hecht & Zajac 1974 by the Addison-Wesley Publication Company. Such a light wave-length specific diffraction grid is formed by applying flat concentric rings of chromium or photographic emulsion to a translucent carrier material. The diffraction grid causes impinging light to be guided through the (round) opening at the center of the grid.

The portion of the light striking the rings is normally lost through reflection unless the rings are made of a material which causes a shift in phase of the impinging light by half a wave length. (See above source, page 376 “phase-reversal zone plate”). In this case, the portion of the light striking the rings is also guided through the opening. According to the state of the art, Fresnel diffraction grids are used in a number of fields (e.g. telecommunications, laser focusing). These diffraction grids may not necessarily be circular in shape. They may also be elliptical to allow correction of optical distortions in the lens systems being used. (Compensation of the angle of incidence of non-collimated light).

The invention can be realized by using monochromatic light in the ultra-violet range or non-monochromatic light the main portion of which lies in the ultra-violet range. Xenon flash units with main portion in the ultra-violet range (e.g. “PX-440” produced by Perkin Elmer, USA), UV-light compatible semiconductor chips with tilting-mirror elements (e.g. “UV-DLP” digital light processing) produced by Texas Instruments, USA) and UV-light sensitive tracing carriers (e.g. “LDI 330 Resist” produced by Dupont, USA) are readily available on the market.

According to the invention, it is possible to make photographic patterns for printed circuit boards. Preferably however, the invention permits the direct exposure of circuit-board material coated with a photosensitive layer, the circuit-board material consisting of an electrically conductive metallic layer and a non-conductive carrier layer.

With direct exposure of this kind, the photographic pattern is no longer required, the circuit board being exposed directly to light without the insertion of a photographic pattern.

The invention can be used to make printing forms for the letterpress, rotogravure, flatbed, screen and silk-screen printing processes.

According to the invention, in cases where the width of an image exceeds the width b of the exposure station, the image can be traced by several passes of the tracing carrier through the exposure station. One image strip of the imaginary overall image is generated at each pass. For such a case, the moving device must be capable of moving not only in direction v, but also vertically to it.

Thus, the invention can be used for various processes involving the tracing of a grid image on a photosensitive tracing carrier.

Applications may also be possible where the photosensitive tracing carrier does not consist of a chemically based material, but of a material which charges electrically when exposed, thereby attracting or repelling printing toners which are sensitive to electrical charges.

The moving device may be driven by a stepping motor, a linear-induction motor or a piezoelectric-crystal device or a combination of these.

1-20. (canceled)

21. Process for tracing a computer-stored grid image on a flat photosensitive carrier, the grid image consisting of grid dots is generated by means of flash light and a light-controlling unit which can be exposed to control patterns by means of a computer program, consisting of light-controlling elements arranged similarly to a matrix,
to which grid-dot positions of the grid image are assigned, a controllable beam of light from each light-controlling element is directed at the tracing carrier to trace an image dot at a grid-dot position assigned to it on a tracing area in an exposure station,
the tracing carrier is moved with reference to the light-controlling unit (or vice versa) with the distance between the level at which the tracing carrier is located and the level at which the light-controlling unit is located remaining constant,
that the tracing carrier (1) executes in a known way a continuous or stepping movement in a straight line in direction, v, with reference to the light-controlling unit (4) (or vice versa),
that the tracing carrier (1), seen in the direction of motion v, is divided into imaginary successive adjacent image fields I1, I2, I3 of the same size,
that for each moment (t1, t2, t3, . . . ) of flash exposure the light-controlling unit (4) is loaded with a control pattern for the tracing of an image section (R1, R2, R3, . . . ) corresponding to that control pattern on the tracing carrier (1) in an exposure station (6), that all the image dots of an image section (R1, R2, R3, . . . ) are traced at the same time,
that the exposure station (6) always assumes the same position with reference to the light-controlling unit (4),
that the exposures to flash take place at moments (t1, t2, t3, . . . ) at which the tracing carrier (1) has moved an equal distance (d) with reference to the light-controlling unit (4) (or vice versa), where the distance of movement (d) is less than the size (h) of an image field (I1, I2, I3, . . . ) or an image section in the direction of movement v.

22. Process according to claim 21, wherein the light-controlling unit (4) is exposed to flash light emitted by a flash unit (5).

23. Process according to claim 22, wherein the conversion of the computer grid image to controllable beams of light for tracing an image takes place by means of a semiconductor chip with tilting mirror elements which is exposed to flash light.

24. Process according to claim 22, wherein the conversion of the computer grid image to controllable beams of light for tracing an image is carried out by a matrix of controllable light-valve elements.

25. Process according to claim 21 wherein the conversion of the computer grid image to controllable beams of light for tracing an image is carried out by a matrix of flash-light emitting elements.

26. Process according to claim 21, wherein the size of the image section (R1, R2, R3, . . . ) generated in the exposure station (6) is determined by a scale-determining lens (7) located between the light-controlling unit (4) and the tracing carrier (1).

27. Process according to claim 21, wherein that the computer-stored grid image to be traced is generated as an overall image (T) by the successive partial overlapping of image sections (R1, R2, R3, R4, . . . ), where the image sections are traced in succession in the exposure station (6) on the tracing carrier (1) at the moments (t1, t2, t3, . . . ) of flash exposure, the tracing carrier (1) has moved an equal distance (d) with reference to the light-controlling unit (4) for each of the moments, where the light-controlling unit (4) receives a control pattern for tracing an image section (R1, R2, R3, R4, . . . ) at each moment (t1, t2, t3, t4, . . . ) of flash exposure, which coincides exactly with a section of the imaginary overall image (T) on the tracing carrier (1).

28. Process according to claim 21, wherein the tracing carrier (1) is moved continuously with reference to the light-controlling unit (4).

29. Process according to claim 21, wherein tracing of the image is carried out with flashes of the same or virtually the same energy in order to achieve a constant depth of tracing on the tracing carrier (1).

30. Process according to claim 21, wherein tracing of the image is carried out in several passes of the tracing carrier (1) through the exposure station (6), where the tracing of the image is carried out with flashes of the same or virtually the same energy within each pass, but where the flash energy varies from one pass to another in order to create tracings with varying depth on the tracing carrier (1).

31. Process according to claim 21, wherein the use of monochromatic light in the ultra-violet range or by the use of non-monochromatic light, the greater part of which is in the ultra-violet range.

32. Process according to claim 21, wherein process is used for manufacturing photographic patterns for printed circuit boards.

33. Process according to claim 21 wherein the process is used for direct exposure of circuit-board material coated with a photosensitive layer, the circuit-board material consisting of an electrically conductive metallic layer and a non-conductive carrier layer.

34. Process according to claim 21 wherein the process is used for manufacturing printing forms for the letterpress, rotogravure, flatbed, screen and silk-screen printing processes.

35. Process according to claim 30, wherein the process is used for manufacturing three-dimensional structures in the photosensitive layer for optical elements for optical or phase focusing.

36. Process according to claim 21, wherein the tracing of an image exceeding the width (b) of the exposure station (6) takes place in several passes of the tracing carrier (1) through the exposure station (6), where a strip (B1′, B2′, B3′, . . . ) of the imaginary overall image is generated at each pass.

37. Process according to claim 21 wherein, in order to reduce the measured deviations from a homogenous tracing thickness z of the individual image dots at the grid positions (p) of the tracing carrier (1) (seen across the direction of movement v of the tracing carrier (1)),
a) the light-controlling elements (c) are controlled by the computer to take account of these deviations in such a way that when image sections are generated, the light-controlling elements for image dots originally of excessive tracing intensity are de-activated,
b) a filter is located between the light-controlling unit (4) and the tracing carrier (1) to compensate for these deviations,
c) the image is traced in several passes of the tracing carrier (1) through the exposure station (6), where an image strip (B1*, B2*) is generated at each pass and where adjacent strips partially (w*) overlap one another towards the edges.

38. Arrangement for tracing a computer-stored grid image on a flat photosensitive carrier, comprising:
the grid image consisting of grid dots is generated by means of flash light and a light-controlling unit exposed to control patterns by a computer program,
controllable light-controlling elements arranged similarly to a matrix, with a moving device on which a tracing carrier is arranged, with a computer for storing the image to be traced on the tracing carrier and for controlling the movement of the light-controlling unit and timing of the exposures,
the moving device (2) can be moved in at least one direction (v) with reference to the light-controlling unit (4) (or vice versa),
that for equidistant movement positions (d) a control pattern is set in the light-controlling unit (4) for tracing an image section (R1, R2, R3, . . . ) for each equidistant position, which pattern is traced simultaneously on the tracing carrier (1) in an exposure station (6) when exposed to flash light,
that the exposure station (6) is always located at the same position with reference to the light-controlling unit (4), and,
that the image section (R1) traced at an equidistant movement position partially overlaps the image section (R2) traced at the next equidistant movement position in such a way that each image section coincides with a section of the grid image (T) on the tracing carrier (1).

39. Arrangement according to claim 38, characterized in that a lens (7) determining the scale of the image section is arranged between the light-controlling unit (4) and the tracing carrier (1).

40. Arrangement according to claim 38, characterized in that the moving device is powered by a stepping motor, a linear-induction motor or a piezoelectric-crystal device or a combination of these.
